(19) United States
(12) Patent Application Publication
(10) Pub. No.: US 2024/0118027 A1
(43) Pub. Date: Apr. 11, 2024

(54) SHOE CARE APPARATUS AND CONTROL METHOD THEREFOR

(71) Applicant: SAMSUNG ELECTRONICS CO., LTD., Suwon-si (KR)

(72) Inventors: Dongpil SEO, Suwon-si (KR); Daegeon KIM, Suwon-si (KR)

(73) Assignee: SAMSUNG ELECTRONICS CO., LTD., Suwon-si (KR)

(21) Appl. No.: 18/545,867

(22) Filed: Dec. 19, 2023

Related U.S. Application Data
(63) Continuation of application No. PCT/KR22/12015, filed on Aug. 11, 2022.

(30) Foreign Application Priority Data
Aug. 20, 2021 (KR) 10-2021-0110131

(51) Int. Cl. F26B 21/08; F26B 9/06; F26B 21/00

(52) U.S. Cl. CPC F26B 21/086; F26B 9/06; F26B 21/004; F26B 21/005

(57) ABSTRACT

A shoe care apparatus includes: a chamber configured to accommodate a shoe; a fan configured to supply air to the chamber; a heat pump device comprising a condenser configured to heat the air and a compressor configured to discharge a refrigerant to the condenser; at least one holder in the chamber and comprising a nozzle configured to spray the air; at least one damper on a side of the chamber, the at least one damper corresponding to the at least one holder so as to adjust supply of the sprayed air; at least one detection sensor in the chamber, the at least one detection sensor being configured to detect the shoe accommodated in the chamber; and a controller configured to control the at least one damper based on a detection signal received from the at least one detection sensor.

### CROSS-REFERENCE TO RELATED APPLICATIONS

This application is a by-pass continuation application of International Application No. PCT/KR2022/012015, filed on Aug. 11, 2022, which is based on and claims priority to Korean Patent Application No. 10-2021-0110131, filed on Aug. 20, 2021, in the Korean Intellectual Property Office, the disclosures of which are incorporated by reference herein their entireties.

### BACKGROUND

### 1. Field

The disclosure relates to a shoe care apparatus including a plurality of nozzles.

### 2. Description of Related Art

Clothes care apparatuses use a heat pump cycle to keep the air in a chamber circulating while performing functions such as drying and deodorizing clothes.

Recently, in addition to clothes care apparatuses using a heat pump cycle, shoe care apparatuses for caring shoes have been developed. A shoe care apparatus is equipped with a sterilizer and a deodorizer as well as a drying function, thereby simultaneously dehumidifying, deodorizing, and sterilizing shoes which are more vulnerable to hygiene than clothing.

A shoe care apparatus includes a chamber forming a space or area for accommodating or containing a shoe and a holder for holding the shoe in the chamber for shoe care. In addition, a nozzle is provided at one end of the holder to supply heated air to an inside of the shoes, thereby enabling dehumidification and deodorization.

### SUMMARY

Provided is a shoe care apparatus that may control air supplied from a plurality of nozzles.

According to an aspect of the disclosure, a shoe care apparatus includes: a chamber configured to accommodate a shoe; a fan configured to supply air to the chamber; a heat pump device comprising a condenser configured to heat the air and a compressor configured to discharge a refrigerant to the condenser; at least one holder in the chamber and comprising a nozzle configured to spray the air; at least one damper on a side of the chamber, the at least one damper corresponding to the at least one holder so as to adjust supply of the sprayed air; at least one detection sensor in the chamber, the at least one detection sensor being configured to detect the shoe accommodated in the chamber; and a controller configured to control the at least one damper based on a detection signal received from the at least one detection sensor.

The at least one detection sensor may include a first detection sensor and a second detection sensor, and wherein the at least one damper may include: a first damper configured to operate based on a first detection signal received from the first detection sensor, and a second damper configured to operate based on a second detection signal received from the second detection sensor.

The controller may be further configured to, based on the first detection signal, close the second damper and open the first damper, and based on the second detection signal, open the second damper and close the first damper.

The controller may be further configured to, based on the first detection signal and the second detection signal, close the second damper and open the first damper for a first predetermined time, and based on the first predetermined time having elapsed, open the second damper and close the first damper for a second predetermined time.

The at least one damper may be configured to block at least a portion of an air hole in an installation rail on the side of the chamber, and to be moved by a motor.

The controller may be further configured to control the motor to determine an amount of movement of the at least one damper.

The shoe care apparatus may further include a steam nozzle provided on the side of the chamber and configured to supply steam into the chamber.

The shoe care apparatus may further include a control panel configured to receive a selection command for a care course from a user, and wherein the controller may be further configured to close at least one of the first damper or the second damper based on the selection command.

The controller may be further configured to close one of the first damper or the second damper corresponding to the at least one detection sensor that does not generate the detection signal.

The controller may be further configured to, based on a single detection signal received from the at least one detection sensor, shorten a time of the care course according to the selection command and control the control panel to output the shortened time.

The shoe care apparatus may further include a control panel configured to receive a selection command for a shoe type from a user, and the controller may be further configured to determine an amount of movement of the at least one damper based on the shoe type.

According to an aspect of the disclosure, a control method of a shoe care apparatus, includes: accommodating a shoe in a chamber; supplying air to the chamber; heating the air by a condenser and discharging a refrigerant to the condenser; spraying the air in the chamber and comprising a nozzle of at least one holder; adjusting supply of the sprayed air by at least one damper provided on a side of the chamber, the at least one damper corresponding to the at least one holder; detecting the shoe accommodated in the chamber by at least one detection sensor in the chamber; and controlling the at least one damper based on a detection signal received from the at least one detection sensor.

The control method may further include: operating a first damper configured to operate based on a first detection signal received from a first detection sensor of the at least one detection sensor, and operating a second damper based on a second detection signal received from a second detection sensor of the at least one detection sensor.

The controlling the at least one damper may include: based on the first detection signal, closing the second damper and opening the first damper, and based on the second detection signal, opening the second damper and closing the first damper.

The controlling the at least one damper may include: based on the first detection signal and the second detection signal, closing the second damper and opening the first damper for a first predetermined time, and based on identifying that the first predetermined time is elapsed, opening the second damper and closing the first damper for a second predetermined time.

According to one or more embodiments of the disclosure, effective dehumidification and deodorization may be performed by selectively controlling air supplied from a plurality of nozzles. Furthermore, energy waste may be reduced by supplying heated air only to a nozzle of a holder on which shoes are actually held.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a shoe care apparatus according to an embodiment;

FIG. 2 is a perspective view illustrating a shoe care apparatus with an open door according to an embodiment;

FIG. 3 is a cross-sectional front view illustrating a shoe care apparatus according to an embodiment;

FIG. 4 illustrates a damper provided in a chamber of a shoe care apparatus according to an embodiment;

FIG. 5 illustrates a damper provided in a chamber of a shoe care apparatus according to another embodiment;

FIG. 6 and FIG. 7 are perspective views illustrating a holder installed in a chamber;

FIG. 8 illustrates an installation rail installed in a chamber;

FIG. 9 is a schematic diagram illustrating a flow of air and refrigerant in a shoe care apparatus according to an embodiment;

FIG. 10 is a control block diagram illustrating a shoe care apparatus according to an embodiment;

FIG. 11 is a flowchart illustrating a control method of a shoe care apparatus according to an embodiment;

FIG. 12 illustrates an operation of a damper in a case where a single shoe is held in a shoe care apparatus according to an embodiment;

FIG. 13 illustrates an operation of a damper in a case where two or more shoes are held in a shoe care apparatus according to an embodiment;

FIG. 14 illustrates a display operation of a control panel according to an embodiment; and

FIG. 15 illustrates an example input of a control panel according to an embodiment.

### DETAILED DESCRIPTION

Like reference numerals throughout the disclosure denote like elements. Also, this disclosure does not describe all the elements according to embodiments of the disclosure, and descriptions well-known in the art to which the disclosure pertains or overlapped portions are omitted. The terms such as “˜part”, “˜member”, “˜module”, “˜block”, and the like may refer to at least one process processed by at least one hardware or software. According to embodiments, a plurality of “˜part”, “˜member”, “˜module”, “˜block” may be embodied as a single element, or a single of “˜part”, “˜member”, “˜module”, “˜block” may include a plurality of elements.

When an element is referred to as being “connected” to another element, it can be directly or indirectly connected to the other element, wherein the indirect connection includes “connection” via a wireless communication network or electrically through electrical wiring.

Further, throughout the disclosure, the terms used herein are used only to describe particular embodiments and are not intended to limit the disclosure. It is to be understood that the singular forms are intended to include the plural forms as well, unless the context clearly dictates otherwise. It will be understood that the terms “include” and “have,” are intended to indicate the presence of the features, numbers, steps, operations, components, parts, or combinations thereof disclosed in the disclosure, but do not preclude the presence or addition of one or more other elements.

Further, such terms as “first” and “second” may be used to simply distinguish a corresponding component from another, and do not represent order of arrangement, order of manufacture, or importance. The term “and/or” includes any and all combinations of one or more of associated listed items.

The terms “forward (or front)”, “backward (or rear)”, “left”, and “right” as used herein are defined with reference to the drawings, but the terms do not limit the shape and position of the respective components.

The term “couple” and the derivatives thereof refer to any direct or indirect communication between two or more elements, whether or not those elements are in physical contact with each other. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: only A, only B, only C, both A and B, both A and C, both B and C, and all of A and B and C. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

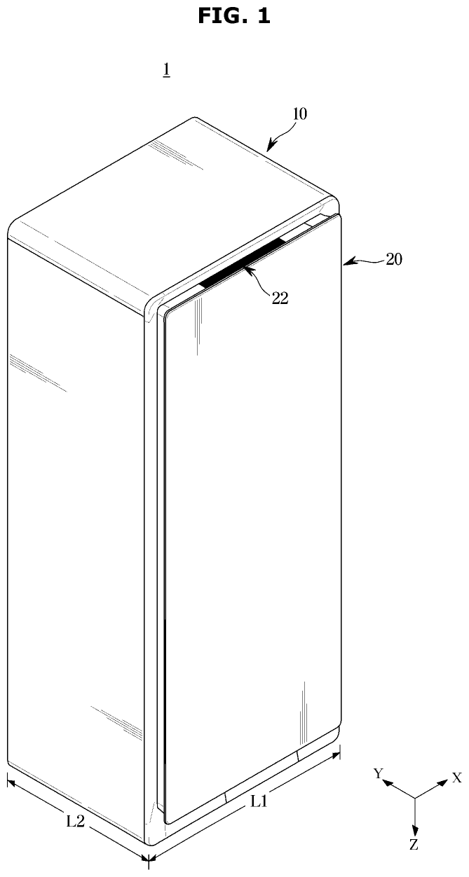

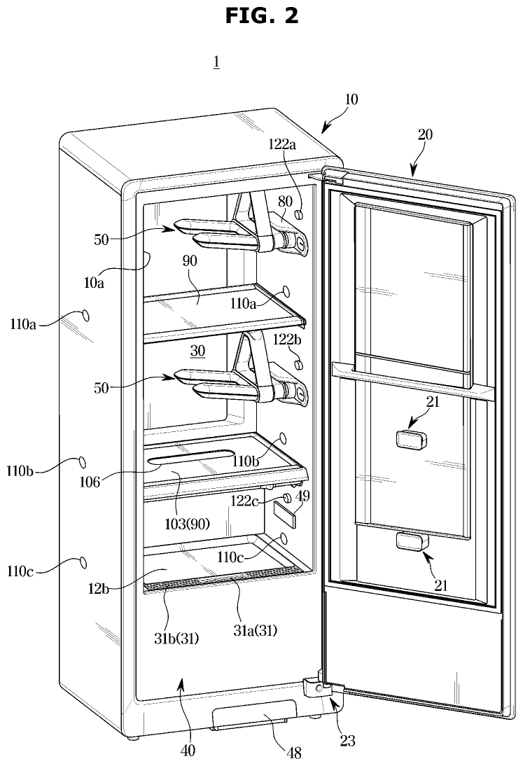

As shown in FIG. 1 and FIG. 2, a direction in which a door 20 of a shoe care apparatus 1 is installed is defined as a front or a front side, and based on the above, rear, left and right sides and upper and lower sides may be defined.

Hereinafter, embodiments of the disclosure are described in detail.

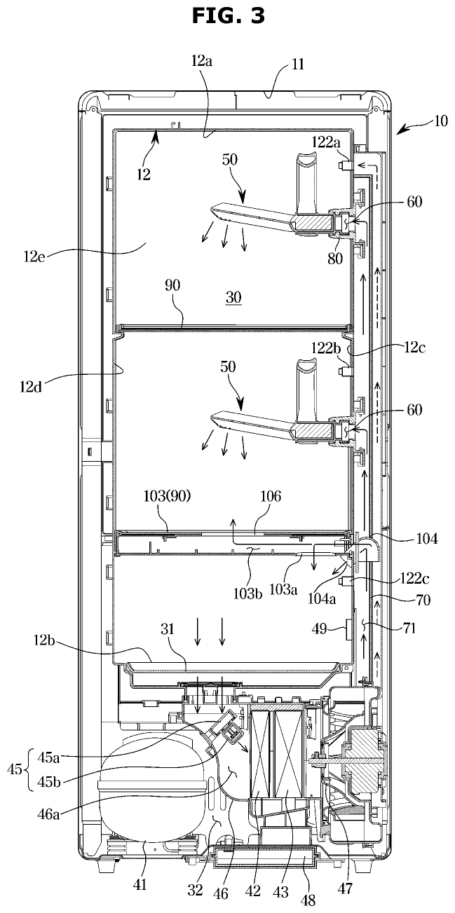

FIG. 1 illustrates a shoe care apparatus according to an embodiment. FIG. 2 is a perspective view illustrating a shoe care apparatus with an open door according to an embodiment FIG. 3 is a cross-sectional front view illustrating a shoe care apparatus according to an embodiment.

Referring to FIG. 1, a shoe care apparatus 1 may include a main body 10 forming an exterior appearance, and a door 20 rotatably coupled to the main body 10.

The main body 10 may be provided in a rectangular shape with an open front side. An opening 10a may be formed on the open front side of the main body 10. The door 20 may be rotatably coupled to the main body 10 to open and close the open front side of the main body 10. The door 20 may be coupled to the main body 10 by a hinge 23.

In the main body 10, a front length L1 extending in a first direction X is different from a side length L2 extending in a second direction Y. That is, the front surface of the main body 10 may be formed in length L1 longer than a length L2 of the side surface of the main body 10. Such a configuration enables the shoe care apparatus 1 to be easily installed even in a narrow entrance hall. The length of the front surface of the main body 10 may be defined as the first length L1 and the length of the side surface of the main body 10 may be defined as the second length L2.

The door 20 may include a control panel 22 arranged on a top surface of the door 20. In an embodiment, the control panel 22 may also be arranged on a front surface of the door 20. The control panel 22 may receive various commands from a user. The control panel 22 may also display various information relating to an operation of the shoe care apparatus 1. In some embodiments, the user may use the control panel 22 to select a type of shoes to be cared for, and to set a suitable care course for the shoes.

The control panel 22 may include a display for displaying information about operations of the shoe care apparatus 1. In an embodiment, the control panel 22 may include at least one of a button or a touch screen.

Referring to FIG. 2, the door 20 may include a hanging member 21. The hanging member 21 may be arranged on one side of the door 20 facing the interior of a chamber 30. At least one hanging member 21 may be provided. The hanging member 21 may be used for hanging a handle 55 of a holder 50. The hanging member 21 may facilitate storage of the holder 50. The hanging member 21 may be used for other purposes.

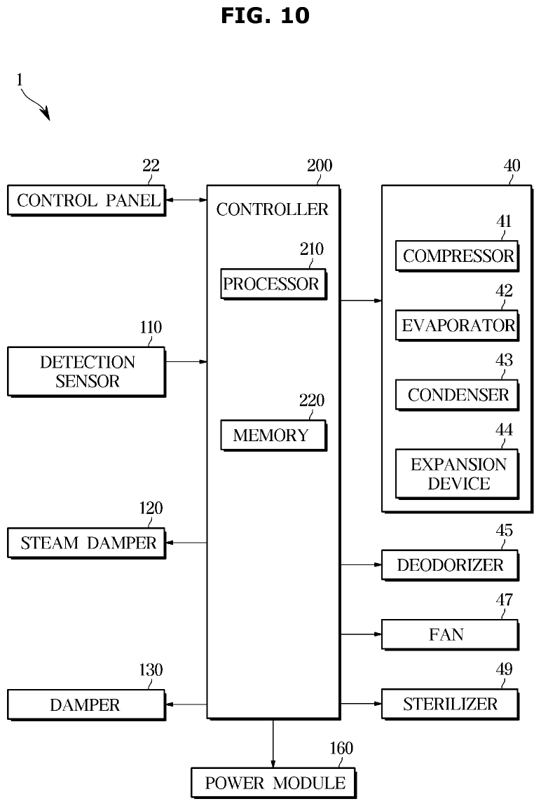

A detection sensor 110 may be installed on a left side (surface) 12c or a right side (surface) 12d of the chamber 30. In response to shoes being held on the holder 50, the detection sensor 110 generates and provides a detection signal to a controller 200 (FIG. 10). The detection sensor 110 may use a variety of known sensors, such as a light receiving sensor that emits infrared light and detects reflected light, a distance detection sensor, and the like.

As shown in FIG. 2, a plurality of detection sensors 110a, 110b, and 110c may each be installed in a space of the chamber 30 separated by at least one shelf 90 or duct shelf 103 to detect the presence of shoes in each space.

A steam nozzle 122 (122a, 122b, 122c) may be installed on the left side 12c or the right side 12d of the chamber 30 to supply steam into the chamber 30. The steam nozzle 122 is provided to spray steam supplied through a steam duct 92 onto the shoes in the chamber 30.

As shown in FIG. 2, a plurality of steam nozzles 122a, 122b, and 122c may each be installed in a space or an area of the chamber 30 separated by the at least one shelf 90 or duct shelf 103 to selectively spray steam.

As shown in FIG. 3, the main body 10 may include an outer case 11 and an inner case 12. The inner case 12 may form the chamber 30. The holder 50 on which shoes may be held may be provided inside the chamber 30. The inner case 12 may be referred to as a case.

The chamber 30 may form a space in which shoes are accommodated. The chamber 30 may include a top surface 12a, a bottom surface 12b, the left side 12c, the right side 12d, and a rear surface 12e of the inner case 12.

The holder 50 and an installation rail 80 may be arranged in the chamber 30. The holder 50 and the installation rail 80 may be installed on the left side 12c of the chamber 30 or the right side 12d of the chamber 30. That is, the holder 50 may be installed to show a side of the shoes when viewed from the front of the shoe care apparatus 1. To this end, the side surface of the main body 10 may be formed in a length shorter than a length of the front surface of the main body 10. However, positions of the holder 50 and the installation rail 80 are not limited thereto.

At least one holder 50 may be provided. The holder 50 may be provided in a shape to be inserted into the shoes. In addition, the holder 50 may be detachable from the chamber 30. That is, the holder 50 may be coupled to the installation rail 80 arranged on the side surface of the chamber 30 and may be detachable from the installation rail 80. For example, the holder 50 may be inserted into the installation rail 80 along the second direction Y. In embodiments where the holder 50 is provided detachably, a space in the chamber 30 may be efficiently used depending on a size of the shoes.

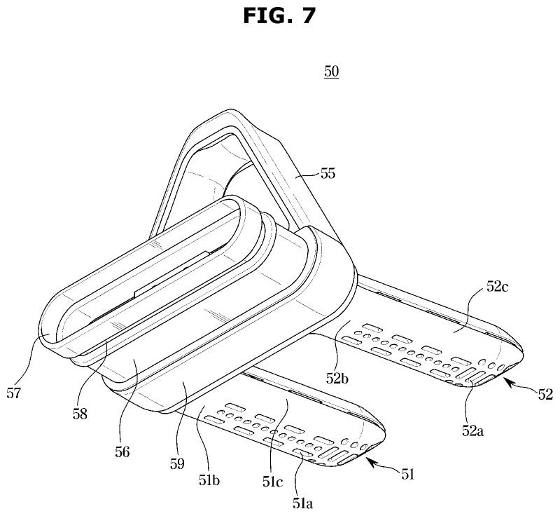

The holder 50 may include nozzles 51a and 52a (FIG. 7). When shoes are held on the holder 50, the holder 50 may supply heated air to the inside of the shoes. The heated air may be sprayed through a second duct 70 and the nozzles 51a and 52a.

The chamber 30 may include an air inlet 60 and an air outlet 31. The air inlet 60 may be formed on a sidewall of the inner case 12. For example, the air inlet 60 may be formed on the left side 12c of the chamber 30. A plurality of air inlets 60 may be provided. Air heated by a condenser 43 may be supplied into the chamber 30 through the air inlet 60. The air inlet 60 may be formed in various shapes. For example, a shape of the air inlet 60 may be circular, rectangular, or polygonal.

The air outlet 31 may be arranged on the bottom surface 12b of the chamber 30. For example, the air outlet 31 may be disposed at a front side of the bottom surface 12b. Air in the chamber 30 may flow to a first duct 46 through the air outlet 31. The air outlet 31 may be comprised of a central hole 31a and a grille 31b including a plurality of side holes.

A machine room 32 may be arranged under the chamber 30. In the machine room 32, a compressor 41, an evaporator 42, the condenser 43, an expansion device 44, a deodorizer 45, the first duct 46, and a fan 47 may be provided. In addition, a sterilizer 49 may be arranged in the chamber 30 or in the machine room 32.

The compressor 41, the evaporator 42, the condenser 43, and the expansion device 44 may be collectively defined as a heat pump device 40. The heat pump device 40 may dehumidify and heat air circulating through the chamber 30. The heat pump device 40 may supply heated air into the chamber 30.

The first duct 46 may be a duct positioned under the chamber 30 and may be referred to as a lower duct. The first duct 46 may be connected to the air outlet 31 to form a first flow path 46a that guides the air having passed the air outlet 31 to the fan 47. Also, the first duct 46 may be connected to a second duct 70 arranged within a side of the main body 10. The second duct 70 may be referred to as an upper duct.

The second duct 70 may be provided outside of a sidewall of the inner case 12 in the second direction Y of the shoe care apparatus 1. One end of the second duct 70 may be connected to at least one supply port (the air inlet 60), and the other end may be connected to the first duct 46. The second duct 70 may form a second flow path 71 that guides air to the supply port (the air inlet 60).

The evaporator 42 and the condenser 43 may be disposed in the first duct 46. The evaporator 42, the condenser 43 and the fan 47 may be arranged in the first direction X. The evaporator 42 may be located upstream of the air flow than the condenser 43.

The steam duct 92 may be arranged in parallel with the second duct 70 outside of the sidewall of the inner case 12 in the second direction 2 of the shoe care apparatus 1. One end of the steam duct 92 may be connected to a steam supply device, and the other end may be connected to the steam nozzle 122. Accordingly, steam generated by the steam supply device may be supplied to the chamber 30 through the steam duct 92 and the steam nozzle 122.

The fan 47 may be provided between the heat pump device 40 and the chamber 30 to circulate air. The fan 47 may rotate based on a predetermined revolutions per minute (RPM). Specifically, the fan 47 may intake air brought into the first duct 46 and discharge the air to the second duct 70. The air brought into the first duct 46 through the air outlet 31 may be dried while passing the evaporator 42 of the heat pump device 40, heated while passing the condenser 43, and then discharged back to the chamber 30 through the second duct 70 and the supply port (air inlet 60).

The fan 47 may include a motor and a blade. The blade may be rotated by motion of the motor, and the rotation of the blade may cause air to flow. The fan 47 may be of various shapes. For example, the fan 47 may be provided as a centrifugal fan.

In an embodiment, the deodorizer 45 may be disposed in the first duct 46. The deodorizer 45 may include a deodorizing filter 45a and ultraviolet light emitting diode (UV LED, 45b). The deodorizing filter 45a and the UV LED 45b may be disposed adjacent to the air outlet 31 of the chamber 30. The UV LED 45b may irradiate light to the deodorizing filter 45a to remove odors from the air. For example, the deodorizing filter 45a may include at least one of a ceramic filter, a photocatalytic filter, or an activated carbon filter.

The sterilizer 49 may be further disposed in the chamber 30 or in the first duct 46. The sterilizer 49 may remove germs contained in the air. The sterilizer 49 may include at least one of an ultraviolet lamp, an ultraviolet LED, a xenon lamp, an ozone generator or a sterilizing spray.

A drain tub 48 may be disposed in a lower portion of the main body 10, i.e. underneath the machine room 32. The drain tub 48 may store condensate water produced by the evaporator 42. The drain tub 48 may be detachable from the main body 10.

At least one shelf 90 may be arranged in the chamber 30. Shoes may be placed on the shelf 90. In addition, the shelf 90 may include the duct shelf 103. The duct shelf 103 may form a flow path 103b therein and may include a hole 103a at a lower surface thereof. Air rising from the fan 47 through the second duct 70 may be discharged into the chamber 30 through the hole 103a of the duct shelf 103. In addition, the duct shelf 103 may be formed with a hole 106 at a top surface thereof.

A side surface of the duct shelf 103 may be connected to a circular duct 104 disposed in the second duct 70. Air may be discharged into the chamber 30 through a circular duct nozzle 104a. Air may be supplied to the duct shelf 103 after passing the circular duct 104. The circular duct 104 may have various shapes. For example, the circular duct 104 may have a fan shape.

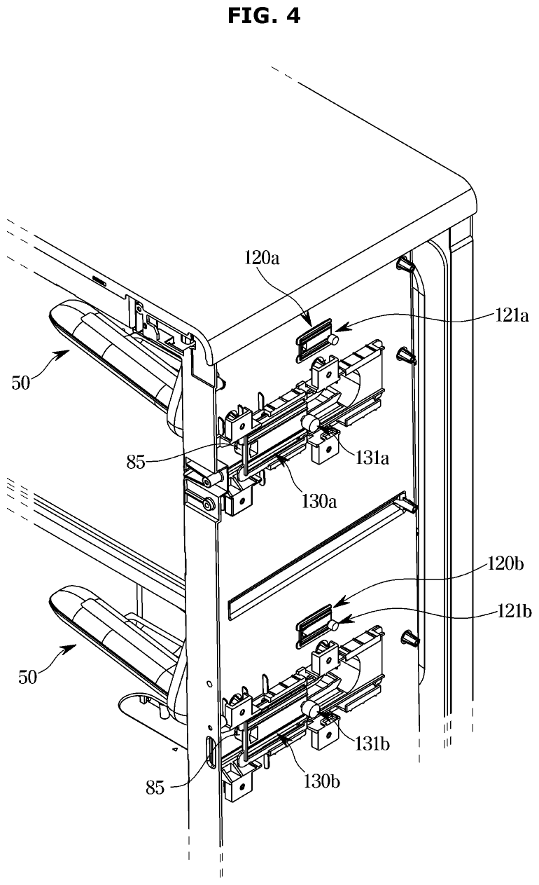

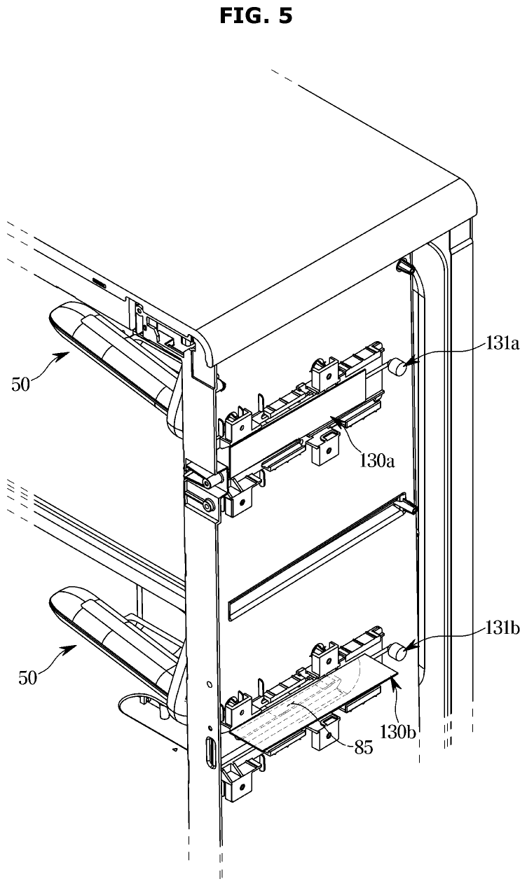

The shoe care apparatus 1 may supply heated air through the second duct 70, and the separated spaces of the chamber 30 share the second duct 70. Accordingly, the heated air is supplied to all the separated spaces simultaneously. However, in a case where shoes are held in only one of the spaces, supplying heated air to all of the spaces may reduce an effect of dehumidification, and the like, as well as cause waste of power. Accordingly, the shoe care apparatus 1 according to the disclosure is provided with a damper 130 that may block the heated air in each of the separated spaces, thereby increasing a dehumidification efficiency in a single space. The damper 130 will be described in detail with reference to FIG. 4 and FIG. 5.

FIG. 4 illustrates a damper provided in a chamber of a shoe care apparatus according to an embodiment FIG. 5 illustrates a damper provided in a chamber of a shoe care apparatus according to another embodiment.

The shoe care apparatus 1 may include a plurality of dampers 130a and 130b provided on the left side 12c of the chamber 30. The shoe care apparatus 1 may include motors 131a and 131b corresponding respectively to the plurality of dampers 130a and 130b. The damper 130 is an opening and closing mechanism for opening or closing flow paths of the nozzles 51a and 52a provided on the holder 50 (FIG. 7), and may be operated by the motor 131. The motor 131 may determine the amount of movement of the damper 130 according to a driving power waveform. The motor 131 (131a, 131b) may determine the amount of movement of the damper 130 by adjusting the rotation amount according to a driving voltage waveform, such as a stepping motor, direct current (DC) brushless motor, synchronous motor, reluctance motor, and the like.

The damper 130 may be opened or closed according to a control signal of the controller 200. For example, according to the control signal of the controller 200, the first damper 130a may be opened and the second damper 130b may be closed, or the first damper 130a may be closed and the second damper 130b may be opened. In this instance, heated air may be supplied only to the nozzles 51a and 52a corresponding to the opened damper 130, without being sprayed to all the spaces or areas of the chamber 30, thereby allowing intensive dehumidification and deodorization.

In addition, the amount of movement of the damper 130 may be determined according to the control signal of the controller 200. According to the control signal of the controller 200, the amount of movement of the first damper 130a or the second damper 130b may be determined, and thus the amount of supplied heated air may be adjusted.

As shown in FIG. 4, the damper 130 according to an embodiment may slide in the second direction Y to open or close an air hole 85. In addition, the damper 130 may adjust the amount of movement in the second direction Y, and thus the amount of supplied heated air may be adjusted.

As shown in FIG. 5, the damper 130 (130a and 130b) according to another embodiment may open or close the air hole 85 by rotating in the second direction Y as a rotation axis. In addition, the damper 130 may adjust the amount of supplied heated air by adjusting the rotation amount based on the second direction Y.

As shown in FIG. 2 and FIG. 3, the shoe care apparatus 1 according to an embodiment may be provided with the steam nozzle 122 (122a, 122b, 122c) on the left side 12c or the right side 12d of the chamber 30 to supply steam into the chamber 30. The steam nozzle 122 may spray steam, supplied through the steam duct 92 (FIG. 3), onto the shoes in the chamber 30. In this instance, the shoe care apparatus 1 is provided with a steam damper 120a or 120b on the left side 12c or the right side 12d of the chamber 30, and thus the spray of steam may be concentrated in one of the separated spaces or areas. The amount of movement or the amount of rotation of the steam damper 120 may be adjusted by a steam motor 121, and operating principles of the damper 130 and the motor 131 may be equally applied to the steam damper 120 and the steam motor 121.

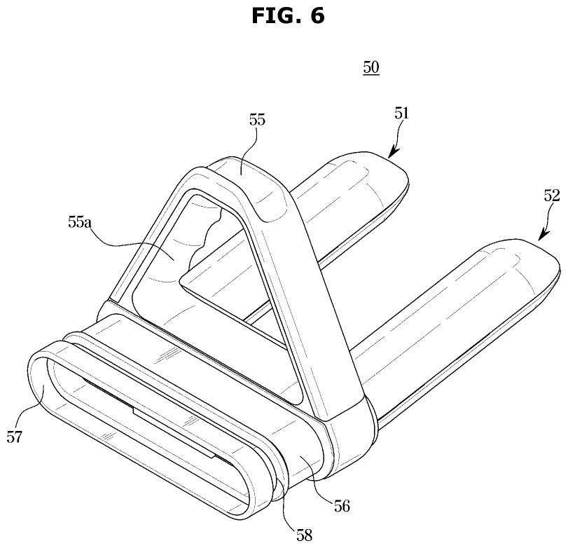

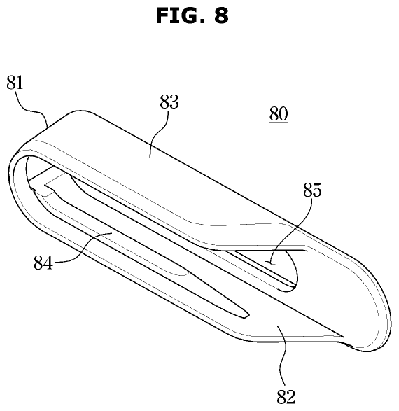

FIG. 6 and FIG. 7 are perspective views illustrating a holder installed in a chamber. FIG. 8 illustrates an installation rail installed in a chamber.

Referring to FIG. 6 and FIG. 7, the holder 50 may include support frames 51 and 52, the handle 55, a support body 56, and a coupler 57. The support body 56 may connect the handle 55, the coupler 57, and a first support frame 51/a second support frame 52.

The first support frame 51 and the second support frame 52 may protrude from a side surface of the chamber 30 in the first direction X and may be spaced apart from each other in the second direction Y. In other embodiments, one or more than two support frames may be provided. In embodiments where the first support frame 51 and the second support frame 52 are spaced apart from each other in the second direction Y, a plurality of shoes may be held thereon.

The support frames 51 and 52 may be inclined at a predetermined angle to prevent the shoes caught from falling out. That is, the support frames 51 and 52 may be inclined upwardly with respect to the bottom surface 12b of the chamber 30. Accordingly, the shoes caught by the holder 50 may be prevented from falling out.

The handle 55 may facilitate moving or detaching the holder 50. A user may move the holder 50 by gripping the handle 55. In addition, the user may easily mount the holder 50 on the installation rail 80 using the handle 55. The handle 55 may be of various shapes. For example, the handle 55 may be provided in a triangular shape. In addition, a grip member 55a may be formed on the handle 55. The user may easily grip the handle 55 using the grip member 55a.

The coupler 57 may be connected to the air inlet 60 and guide the air supplied through the second duct 70 to the support frames 51 and 52. The coupler 57 is shown as having a hollow oval shape, but is not limited thereto and may be provided in various shapes.

Referring to FIG. 7, the first support frame 51 and the second support frame 52 of the holder 50 may include a first nozzle 51a and a second nozzle 52a, respectively. The nozzles 51a and 52a may be formed on at least one of bottom surfaces 51b and 52b or side surfaces 51c and 52c of the support frame. The nozzles 51a and 52a may be provided in various shapes. For example, the nozzles 51a and 52a may be circular, elliptical or rectangular. Heated air may be supplied to each of the separated spaces or areas of the chamber 30 through the nozzles 51a and 52a.

The holder 50 may further include a fastening groove 58. A fixing projection 84 of the installation rail 80 may be inserted into the fastening groove 58 to fix the holder 50. The holder 50 may further include a reinforcing member 59. The reinforcing member 59 may be connected to the handle 55 to reinforce the support body 56.

FIG. 8 illustrates an installation rail installed in a chamber.

Referring to FIG. 8, one end 81 of the installation rail 80 may be closed to prevent the holder 50 from falling out, and the other end 82 of the installation rail 80 may have an open form to allow the holder 50 to be inserted therein. The installation rail 80 may include a fixing frame 83 and a fixing projection 84.

The fixing frame 83 may extend from the one end 81 of the installation rail 80 to the other end 82, and may receive the coupler 57 of the holder 50. The fixing projection 84 may be inserted into the fastening groove 58 of the holder 50. The holder 50 may thus be fixed to the installation rail 80. The holder 50 may be detachable from the installation rail 80.

Also, the installation rail 80 may include the air hole 85. Air brought in through the second duct 70 and the air inlet 60 of the chamber 30 may be supplied to the holder 50 through the air hole 85 in the installation rail 80. That is, air brought in from the air inlet 60 may be supplied to the support frames 51 and 52 of the holder 50 through the air hole 85, and may be sprayed into the chamber 30 through the nozzles 51a and 52a.

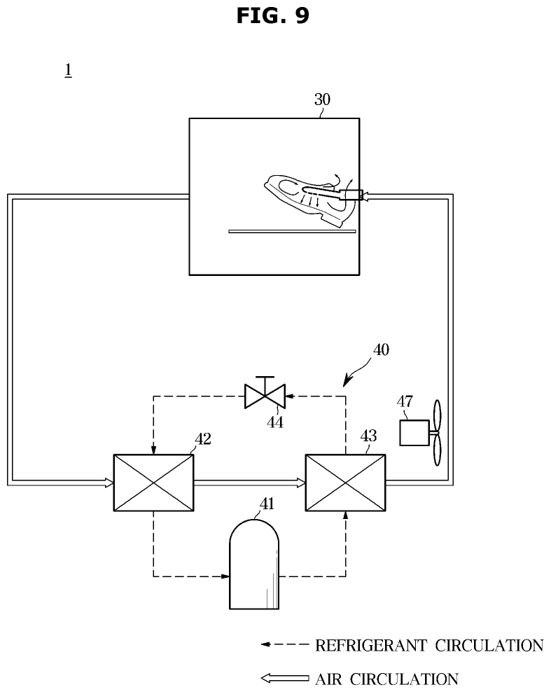

FIG. 9 is a schematic diagram illustrating a flow of air and refrigerant in a shoe care apparatus according to an embodiment.

Referring to FIG. 9, the shoe care apparatus 1 according to an embodiment may include the chamber 30 for receiving shoes S, the heat pump device 40 dehumidifying and heating air in the chamber 30 to dry the shoes S, and the fan 47 provided between the chamber 30 and the heat pump device 40 for circulating air.

The heat pump device 40 includes the compressor 41, the condenser 43, the expansion device 44, and the evaporator 42. The compressor 41, the condenser 43, the expansion device 44, and the evaporator 42 may be connected to each other by refrigerant pipes to form a heat pump cycle, and a refrigerant may be circulated in accordance with the heat pump cycle while flowing in the refrigerant pipes.

The compressor 41 compresses a low-temperature and low-pressure vapor-phase refrigerant and discharges a high-temperature and high-pressure vapor-phase refrigerant. The discharged vapor-phase refrigerant may flow into the condenser 43, and the high-temperature and high-pressure vapor-phase refrigerant may be condensed into a high-pressure liquid-state or approximately liquid-state refrigerant substantially equal to or lower than a condensation temperature. The high-pressure liquid-state or approximately liquid-state refrigerant that has passed the condenser 43 may be expanded and decompressed by the expansion device 44, and the low-temperature and low-pressure two-phase refrigerant that has passed the expansion device 44 may flow into the evaporator 42. The two-phase refrigerant may be evaporated to vapor-phase refrigerant in the evaporator 42.

The chamber 30 and the heat pump device 40 may be connected by the first duct 46 and the second duct 70, and the air in the chamber 30 may move through the ducts and may be circulated between the heat pump device 40 and the chamber 30.

Hot and humid air from the chamber 30 may exchange heat with the refrigerant while passing the evaporator 42. Specifically, the low-temperature and low-pressure two-phase refrigerant brought into the evaporator 42 may be evaporated into a vapor-phase refrigerant by absorbing heat from the hot and humid air passing the evaporator 42. The hot and humid air passing the evaporator 42 may be thereby cooled and dehumidified simultaneously into cool and dry air.

After passing the evaporator 42, the cool and dry air may flow into the condenser 43, and heat exchange may occur between the high-temperature and high-pressure vapor-phase refrigerant and the cool and dry air in the condenser 43. The high-temperature and high-pressure vapor-phase refrigerant may release heat while being condensed into a liquid-phase or approximately liquid-phase refrigerant, and the cool and dry air may be heated by absorbing the heat released during the condensation of the refrigerant.

The hot and dry air having passed the condenser 43 may flow back into the chamber 30. The shoes S accommodated in the chamber 30 may be dried by such an air circulation cycle.

The expansion device 44 may be implemented with at least one of a capillary tube or an electrical expansion valve that may control opening degrees based on an electrical signal. The compressor 41 may be implemented as a frequency changeable inverter compressor. A frequency of the compressor 41 refers to revolutions per second of a motor connected to a compression room of the compressor 41. The compressor 41 may operate at a predetermined starting frequency at the start of a dry course, and afterward, to increase the temperature, the compressor 41 may operate at an operation frequency. The compressor 41 may operate within a range from a minimum frequency and a maximum frequency. A minimum operation frequency and a maximum operation frequency may be set in advance depending on the design.

FIG. 10 is a control block diagram illustrating a shoe care apparatus according to an embodiment.

Referring to FIG. 10, the shoe care apparatus 1 may include the control panel 22, the heat pump device 40, the deodorizer 45, the fan 47, the sterilizer 49, a power module 160, and the controller 200. In an embodiment, the shoe care apparatus 1 may further include a communication device for transmitting and receiving data with an external device. The controller 200 may be electrically connected to the aforementioned components of the shoe care apparatus 1 and control operations of the components.

The power module 160 may supply power to the components of the shoe care apparatus 1. The power module 160 may be implemented with a printed circuit board and a power circuit mounted on the printed circuit board. For example, the power module 160 may include a capacitor, a coil, a resistor, a processor, and the like, which are mounted on the power circuit board.

The controller 200 may include a memory 220 recording and/or storing programs, instructions and data for controlling operations of the shoe care apparatus 1, and a processor 210 generating a control signal for controlling operations of the shoe care apparatus 1 based on the programs, instructions and/or data recorded and/or stored in the memory 220. The controller 200 may be implemented as a control circuit in which the processor 210 and the memory 220 are mounted. The controller 200 may also include a plurality of processors and a plurality of memories.

The processor 210 may include a logic circuit and an arithmetic circuit in hardware. The processor 210 may process data according to the program and/or instruction provided from the memory 220, and generate a control signal according to a result of the processing. For example, based on a user input of a command to select a care course through the control panel 22, the shoe care apparatus 1 may perform an operation corresponding to the selected care course.

The memory 220 may include a volatile memory, such as Static Random Access Memory (S-RAM) or Dynamic Random Access Memory (D-RAM), for temporary storage of data, and a non-volatile memory, such as Read Only Memory (ROM), Erasable Programmable Read Only Memory (EPROM), or Electrically Erasable Programmable Read Only Memory (EEPROM), for long-term storage of data.

As described in FIG. 1, the control panel 22 may be arranged on the door 20 (a top surface of the door 20). In other embodiments, the control panel 22 may be provided in various positions. The controller 200 may determine a target temperature based on a selection of a shoe type and care course through the control panel 22. Also, the controller 200 may determine an operation time of the shoe care apparatus 1 based on the selected shoe type and care course.

A user may use the control panel 22 to select a shoe type to be cared for. For example, the control panel 22 may provide at least one of a shoe type menu to allow the user to select a shoe type, or a care course menu to allow the user to select a care course. Shoe types may include types according to use or shape, such as dress shoes, sneakers, hiking shoes, boots, sandals, rain boots, and the like. The shoe types may also include types according to material, such as leather, cotton, nylon, synthetic materials, silk, enamel, suede, neoprene, and the like.

The controller 200 may determine a target temperature of air to be supplied into the chamber 30 based on a shoe type. Because different types of shoes have different characteristics, the target temperature for caring the shoes may be set differently according to the characteristics of the shoes. For example, for shoes of synthetic materials, a low target temperature of 30 degrees Celsius or higher and less than 38 degrees Celsius may be set. For shoes of a leather material, a medium target temperature of 38 degrees Celsius or higher and less than 43 degrees Celsius may be set. For shoes of a cotton material, a high target temperature of 43 degrees Celsius or higher and less than 60 degrees Celsius may be set. As another example, when two or more types of shoes are to be cared for or the shoes contain moisture, a target temperature for dehumidification may be set to less than 40 degrees Celsius and a target temperature for deodorization may be set to 40 degrees Celsius or higher and less than 60 degrees Celsius. Through the above, damage to the shoes may be prevented. Furthermore, when both dehumidification and deodorization are desired, deodorization may be performed after dehumidification. For example, the moisture contained in the shoes may be removed at a low temperature and deodorization may then be performed at a high temperature, thereby minimizing the damage to the shoes.

In some embodiments, the controller 200 may determine the amount of air to be supplied into the chamber 30 based on a shoe type. By controlling the amount of movement of the damper 130, the controller 200 may adjust the amount of air supplied through the nozzles 51a and 52a (FIG. 6). For example, shoes made of synthetic materials may be supplied with a small amount of air by setting a degree of opening of the damper 130 to 30%. Shoes made of leather may be supplied with a moderate amount of air by setting the degree of opening of the damper 130 to 50%. Shoes made of cotton may be supplied with a large amount of air by setting the degree of opening of the damper 130 to 100%.

In some embodiments, the user may use the control panel 22 to set a suitable care course. The controller 200 may determine an operation time of the shoe care apparatus 1 based on the selected care course. For example, the care course may include at least one of a standard course, a quick course, an intense course, or a clean storage course. The standard course may be a default care course, and may be defined as a care course in which the shoe care apparatus 1 is operated for a standard time (e.g., 30 minutes) for which dehumidification and deodorization effects are normally exerted. The quick course may be defined as a care course that may exert minimum dehumidification and deodorization effects within a shorter time than in the standard course. The intense course may be defined as a care course that may exert maximum dehumidification and deodorization effects by being operated for a longer time than in the standard course. Furthermore, the clean storage course may be defined as a care course for keeping the shoes for a long time. As such, various care courses may be suitably applied to various shoes, thereby increasing convenience of shoe caring and user satisfaction.

The controller 200 may determine an operation frequency of the compressor 41 based on a target temperature and an outside air temperature, and may operate the compressor 41 at the determined operation frequency. The target temperature and the outside air temperature are factors that may heavily influence determination of the operation frequency of the compressor 41. For example, based on the outside air temperature being a low temperature, the operation frequency of the compressor 41 may be set to a high value to force the temperature of the air supplied into the chamber 30 to quickly reach the target temperature. The larger the difference between the outside air temperature and the target temperature, the higher the value that the operation frequency of the compressor 41 may be set to. In contrast, based on the difference between the target temperature and the outside air temperature being small (e.g., when the difference between the target temperature and the outside air temperature is 10 É degrees Celsius or less), the operation frequency of the compressor 41 may be set to a low value, because when the temperature in the chamber 30 rises suddenly, it may exceed the target temperature.

In an embodiment, the controller 200 may adjust the operation frequency of the compressor 41 based on the temperature of the air heated by the condenser 43 and the target temperature.

Each component of the shoe care apparatus 1 according to the disclosure and the operation of each of the components have been described above. Hereinafter, a control method of the shoe care apparatus 1 is described in detail.

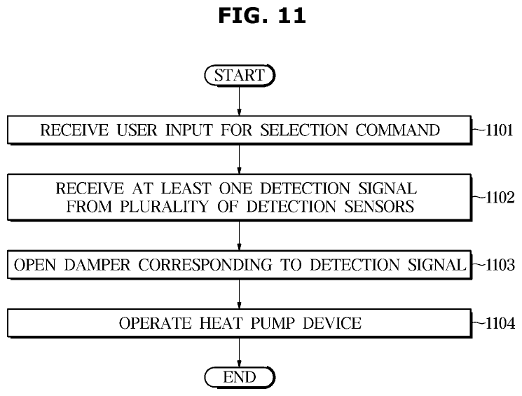

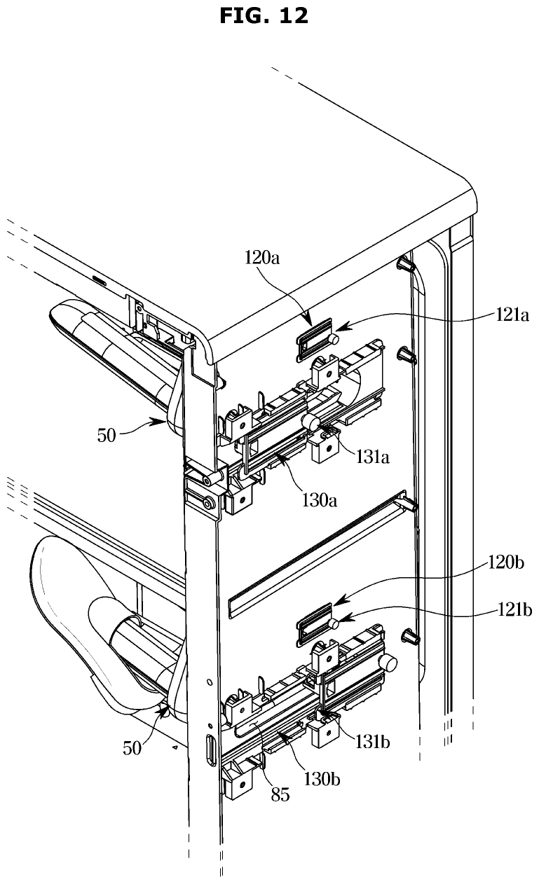

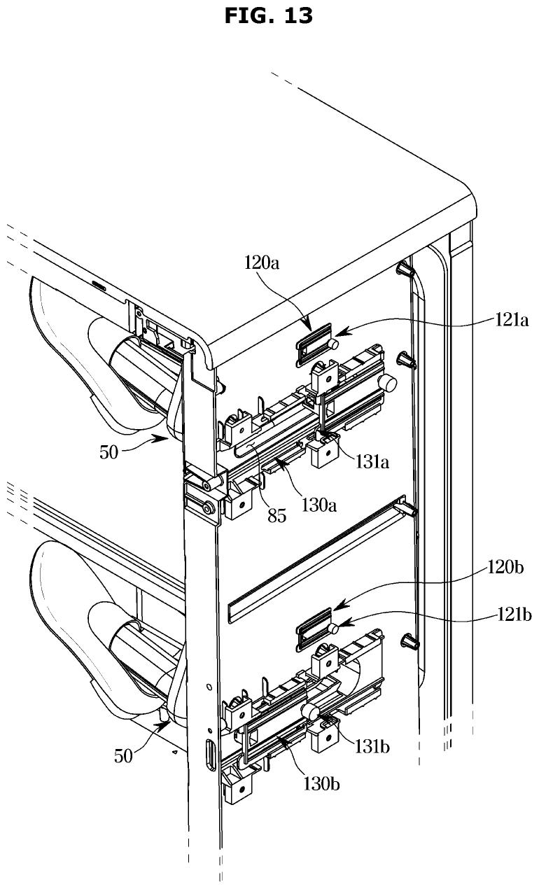

FIG. 11 is a flowchart illustrating a control method of a shoe care apparatus according to an embodiment. FIG. 12 illustrates an operation of a damper in a case where a single shoe is held in a shoe care apparatus according to an embodiment. FIG. 13 illustrates an operation of a damper in a case where two or more shoes are held in a shoe care apparatus according to an embodiment.

The shoe care apparatus 1 receives a user input for a selection command (operation 1101). In this instance, the user's selection command may be an input to the control panel 22 for a care course or for a shoe type. For example, a user may select one of a standard course, a quick course, an intense course, or a clean storage course through the control panel 22. In addition, the user may select one of dress shoes, sneakers, hiking boots, boots, sandals, rain boots, etc., through the control panel 22 and set a target temperature according to the input shoe type.

The shoe care apparatus 1 receives at least one detection signal from the plurality of detection sensors 110 (operation 1102). As shown in FIG. 2, in response to the shoes accommodated in the chamber 30 being detected, the plurality of detection sensors 110a, 110b, and 110c generate a detection signal and transmit the detection signal to the controller 200. For example, in response to shoes accommodated in an upper portion of the chamber 30 being detected, the first detection sensor 110a generates a first detection signal and transmits the first detection signal to the controller 200. In response to shoes accommodated in a middle portion of the chamber 30 being detected, the second detection sensor 110b generates a second detection signal, and transmits the second detection signal to the controller 200. In response to shoes in a lower portion of the chamber 30 being detected, the third detection sensor 110c generates a third detection signal and transmits the third detection signal to the controller 200. However, the example shown in FIG. 2 is only an example, and the chamber 30 may form two or more separated spaces or areas.

The shoe care apparatus 1 opens the damper 130 corresponding to the detection signal (operation 1103). The shoe care apparatus 1 according to the disclosure may accommodate three shoes. The shoe care apparatus 1 according to the embodiment is for preventing waste of power consumption in a space or area where no shoes are accommodated, when a user desires to care shoes in one of the separated spaces or areas of the chamber 30. Accordingly, the shoe care apparatus 1 according to the disclosure may perform intensive care only in the space or area where the shoes are actually accommodated by opening only the damper 130 corresponding to the detection signal.

The shoe care apparatus 1 according to an embodiment may control at least one of the plurality of dampers 130 based on the detection signal received from the plurality of detection sensors 110.

The plurality of dampers 130 according to an embodiment may include the first damper 130a that operates based on the first detection signal received from the plurality of detection sensors 110a and the 110b, and the second damper 130b that operates based on the second detection signal received from the second detection sensor 110b among the plurality of detection sensors 110a and the 110b. In addition, according to another embodiment, the plurality of dampers 130 may further include a third damper that operates based on the third detection signal received from the third detection sensor 110c. The third damper corresponds to a device that may pass or block heated air in the space or area provided at a lower portion of the chamber 30. Once the third damper is opened, heated air may be supplied to the lower portion of the chamber 30 through the circular duct nozzle 104a (see FIG. 3).

In response to receiving the first detection signal, the shoe care apparatus 1 according to an embodiment may open the second damper 130b along with opening the first damper 130a, and in response to receiving the second detection signal, the shoe care apparatus 1 may open the second damper 130b along with closing the first damper 130a. As a result, the shoe care apparatus 1 may open only the damper 130 at a position where the shoe is accommodated and supply the air heated by the heat pump device 40 to only one shoe. In this instance, the operation of the damper 130 may be initiated in response to a user input to the control panel 22. For example, referring to FIG. 12, the shoe care apparatus 1 may open the second damper 130b at a position where the shoe is accommodated, and close the first damper 130a at a position where no shoe is accommodated.

In addition, referring to FIG. 13, in a case where shoes are accommodated in a plurality of spaces or areas, the shoe care apparatus 1 according to an embodiment may selectively care the shoes according to the priority set in advance by a user. In response to receiving the first detection signal and the second detection signal, the shoe care apparatus 1 may close the second damper 130b along with opening the first damper 130a for a first predetermined time. In response to the first predetermined time having elapsed, the shoe care apparatus 1 may open the second damper 130b along with closing the first damper 130a for a second predetermined time. In this case, the user may determine a space or area where shoes are to be cared for with the highest priority among the separated spaces or areas of the chamber 30 through the control panel 22.

The shoe care apparatus 1 operates the heat pump device 40 (operation 1104). In some embodiments, the shoe care apparatus 1 may open only one of the plurality of dampers 130a and 130b, and supply the heated air generated by the heat pump device 40 to only one of the separated spaces or areas of the chamber 30.

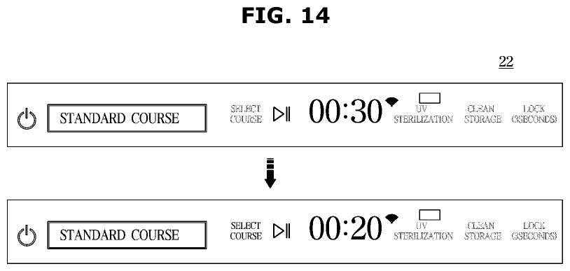

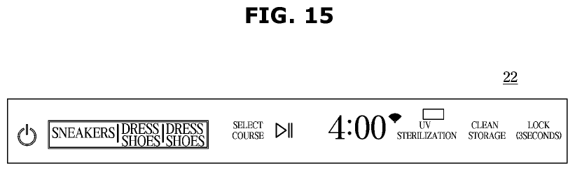

Control of the damper 130 in the shoe care apparatus 1 has been described above. The shoe care apparatus 1 according to the disclosure may supply heated air to only one of the separated spaces or areas of the chambers 30, thereby reducing the care time. In some embodiments, the shoe care apparatus 1 according to the disclosure may control the amount of supplied air by adjusting the amount of movement of the damper 130 according to a shoe type, which is described with reference to FIG. 14 and FIG. 15.

FIG. 14 illustrates a display operation of a control panel according to an embodiment FIG. 15 illustrates an example input of a control panel according to an embodiment.

In response to a single detection signal being detected from the plurality of detection sensors 110a, 110b, and 110c, the shoe care apparatus 1 according to an embodiment opens only the damper 130 corresponding to the detection sensor 110 that has generated the detection signal. As a result, an actual operation time of the shoe care apparatus 1 may be reduced. The shoe care apparatus 1 may close one of the first damper 130a or the second damper 130b in response to receiving a selection command for a care course from a user. In this instance, the shoe care apparatus 1 may close the damper 130 corresponding to the detection sensor 110 that does not generate a detection signal. In response to a single detection signal being detected from the plurality of detection sensors 110a, 110b, and 110c, the shoe care apparatus 1 shortens a time of the care course according to the selection command, and controls the control panel 22 to output the shortened time. Referring to FIG. 14, in a case where the user selects a standard course that generally takes 30 minutes among the care courses and only one detection signal is generated from the plurality of detection sensors 110a, 110b, and 110c, the shoe care apparatus 1 may output 20 minutes which is a shortened time from 30 minutes.

In another embodiment, referring to FIG. 15, the shoe care apparatus 1 may receive a selection command for a shoe type from a user through the control panel 22. In this instance, as shown in FIG. 15, the control panel 22 may output a display for selecting a shoe type for each separated space or area of the chamber 30. In response to a shoe type being selected by the user through the control panel 22, the shoe care apparatus 1 may determine the amount of movement of the damper 130 according to the selected shoe type.

The disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored. For example, there may be a Read Only Memory (ROM), a Random Access Memory (RAM), a magnetic tape, a magnetic disk, a flash memory, and an optical data storage device.

The disclosure has been shown and described in relation to specific embodiments. Those skilled in the art will understand that changes and modifications may be made in these embodiments without departing from the principles and scope of the disclosure, the scope of which is defined in the claims and their equivalents.

What is claimed is:

1. A shoe care apparatus comprising:
a chamber configured to accommodate a shoe;
a fan configured to supply air to the chamber;
a heat pump device comprising a condenser configured to heat the air supplied to the chamber and a compressor configured to discharge a refrigerant to the condenser;
at least one holder in the chamber and comprising a nozzle configured to spray the air;
at least one damper on a side of the chamber, the at least one damper corresponding to the at least one holder so as to adjust supply of the sprayed air;
at least one detection sensor in the chamber, the at least one detection sensor being configured to detect the shoe accommodated in the chamber; and
a controller configured to control the at least one damper based on a detection signal received from the at least one detection sensor.

2. The shoe care apparatus of claim 1, wherein the at least one detection sensor comprises a first detection sensor and a second detection sensor, and
wherein the at least one damper comprises:
a first damper configured to operate based on a first detection signal received from the first detection sensor, and
a second damper configured to operate based on a second detection signal received from the second detection sensor.

3. The shoe care apparatus of claim 2, wherein the controller is further configured to, based on the first detection signal, close the second damper and open the first damper, and
based on the second detection signal, open the second damper and close the first damper.

4. The shoe care apparatus of claim 2, wherein the controller is further configured to, based on receiving the first detection signal and the second detection signal, close the second damper and open the first damper for a first predetermined time, and
based on the first predetermined time having elapsed, the controller is further configured to open the second damper and close the first damper for a second predetermined time.

5. The shoe care apparatus of claim 1, wherein the at least one damper is configured to block at least a portion of an air hole in an installation rail on the side of the chamber, and to be moved by a motor.

6. The shoe care apparatus of claim 5, wherein the controller is further configured to control the motor to determine an amount of movement of the at least one damper.

7. The shoe care apparatus of claim 1, further comprising a steam nozzle provided on the side of the chamber and configured to supply steam into the chamber.

8. The shoe care apparatus of claim 2, further comprising a control panel configured to receive a selection command for a care course from a user, and
wherein the controller is further configured to close at least one of the first damper or the second damper based on the selection command.

9. The shoe care apparatus of claim 8, wherein the controller is further configured to close one of the first damper or the second damper corresponding to the at least one detection sensor that does not generate the detection signal.

10. The shoe care apparatus of claim 8, wherein the controller is further configured to, based on receiving a single detection signal from the plurality of detection sensors, shorten a time of the care course according to the selection command and control the control panel to output the shortened time.

11. The shoe care apparatus of claim 2, further comprising a control panel configured to receive a selection command for a shoe type from a user, and
wherein the controller is further configured to determine an amount of movement of the at least one damper based on the shoe type.

12. A control method of a shoe care apparatus, the control method comprising:
accommodating a shoe in a chamber;
supplying air to the chamber;
heating the air by a condenser and discharging a refrigerant to the condenser;
spraying the air in the chamber and comprising a nozzle of at least one holder;
adjusting supply of the sprayed air by at least one damper provided on a side of the chamber, the at least one damper corresponding to the at least one holder;
detecting the shoe accommodated in the chamber by at least one detection sensor in the chamber; and
controlling the at least one damper based on a detection signal received from the at least one detection sensor.

13. The control method of claim 12, further comprising:
operating a first damper configured to operate based on a first detection signal received from a first detection sensor of the at least one detection sensor, and
operating a second damper based on a second detection signal received from a second detection sensor of the at least one detection sensor.

14. The control method of claim 13, wherein the controlling the at least one damper comprises:
based on the first detection signal, closing the second damper and opening the first damper, and
based on the second detection signal, opening the second damper and closing the first damper.

15. The control method of claim 13, wherein the controlling the at least one damper comprises:
based on the first detection signal and the second detection signal, closing the second damper and opening the first damper for a first predetermined time, and
based on the first predetermined time having elapsed, opening the second damper and closing the first damper for a second predetermined time.
